(19) United States
(12) Patent Application Publication
(10) Pub. No.: US 2021/0008915 A1
(43) Pub. Date: Jan. 14, 2021

(54) METHOD FOR PRINTING A PRINTING, WHICH IS DESIGNED AS A COLOR-TILTING SURFACE, ONTO THE SURFACE OF AT LEAST ONE OBJECT

(71) Applicant: Schreiner Group GmbH & Co. KG, Oberschleissheim (DE)

(72) Inventors: Oliver WEISS, Muenchen (DE); Roland GROETZNER, Unterschleissheim (DE); Katja SCHUMACHER, Winnenden (DE)

(73) Assignee: Schreiner Group GmbH & Co. KG, Oberschleissheim (DE)

(21) Appl. No.: 17/040,193

(22) PCT Filed: Mar. 25, 2019
(86) PCT No.: PCT/EP2019/057440

§ 371 Date: Sep. 22, 2020

(30) Foreign Application Priority Data
Mar. 23, 2018 (DE) 10 2018 106 966.9

(51) Int. Cl. B41M 3/14

(52) U.S. Cl. CPC B41M 3/148

(57) ABSTRACT

A method for printing a printing designed as a color-tilting surface onto an object surface includes a) printing a relief structure having strip-shaped webs onto the object surface, the strip-shaped webs being spaced apart and raised relative to the surface and each having first and second side flanks, and b) conformal printing of a pattern with first color strips parallel to but laterally offset from the webs. As a result, the first color strips more strongly determine color, brightness and/or another visual, optical or wavelength-related property viewed obliquely from the first side flanks than viewed obliquely from the second side flanks. At least in step b) a digital printing technique carries out the printing to permit variable predetermination of at least the first color strip dimensions, positions and/or contours. A colored isotropic printing ink and/or printing compound is used as the printing ink and/or printing compound.

The invention relates to a method for printing an imprint that is structured as a color-shift surface, at least in certain regions, onto the surface of at least one object. The application furthermore relates to such an imprint, which serves for individual marking of the surface of an object, as well as to a set of objects that are provided with such imprints.

In numerous areas of application, objects of the most varied types must be marked and inscribed, generally with the aid of labels, but also, in part, by means of marking the surface of the object itself. Marking generally takes place by means of printing onto the label, a container or the other object. The information to be imprinted includes, for example, the type, content, and amount of the object (for example in the case of chemicals, medications, and other products in medicine or pharmaceutics) or special information regarding use, administration, operation or warnings for dealers, sellers, end consumers and other relevant members of the public. For this purpose, common printing techniques are used, just as in the case of written materials, printed materials or other documents. Bar codes and QR codes can also be imprinted in this manner.

Furthermore, special security features exist, which are not or not exclusively intended for overt information for everyone, but rather serve as forgery protection, copying protection or as a feature that is relevant to security in some other manner, for example as security features of banknotes, of documents or badges issued by state or other authorized offices and administrations, of authorization IDs, insurance cards and check cards, etc.

Such security features have a more complicated structure; they include those having a color-shift effect, among others. For example, it is possible to print color-shift surfaces, the color, brightness or other visual impression of which depends on the line of sight, i.e. the viewing direction of the human eye relative to the orientation of the color-shift surface.

Conventionally, two different methods exist for producing an imprint that has a color-shift effect. In the case of the one method, a relief pattern composed of many parallel ridges composed of printing ink having a second, contrasting color is imprinted onto a substratum that possesses a first color; narrow strips of the substratum surface remain more or less visible between the ridges, depending on the line of sight. The strip pattern is so delicate that the strips and their interstices cannot be individually resolved with the naked eye, or this is only possible with difficulty. In contrast, the color impression of the relief-type surface can be very well perceived with the naked eye, and changes with the viewing angle when looking at the surface at a slant, at least when the plane formed by the line of sight and the normal line to the surface lies perpendicular to the course of the relief lines. In this plane, viewing at a flat angle leads to the result that the grooves between the ridges are covered, in whole or in part, i.e. they seem to disappear, more or less, and for this reason the relief-type surface appears to assume a changed color from this direction, which color is predominantly determined by the color of the material of the ridges. In contrast, in the direction parallel to the ridges, the color impression observed is essentially no different, even when looking at a slant, than when looking at a right angle, looking from the normal line direction.

The above effect is based on the geometric coverage of relief grooves by raised lines, i.e. by line-shaped or, to state it more precisely, strip-shaped ridges. This mechanism has mirror symmetry within an intersection plane in the case of different lines of sight, with reference to the normal line direction of the surface, i.e. it is identical for the lines of sight at the angles α and −α, and is most strongly marked in the intersection plane perpendicular to the ridges.

The other method is based on the appearance of specific printing ink layers themselves, which varies in color depending on the line of sight. There are printing inks having small particles, in particular having thin-layer structures, which are shaped in flake-like manner, i.e. essentially have a planar structure and possess an appearance and, in particular, a color, due to interference effects, that is optically anisotropic. Depending on the viewing direction relative to the plane of the layer boundaries, theses flake-shaped particles appear in a changeable color; the same holds true for a sufficiently thin printed layer having such particles, which deposit, for the most part, parallel to the underlying surface or boundary surface, and as a result, the coated surface is also given a color that appears to change as a function of direction.

If one were to print such optically anisotropic printing inks onto a structured surface, for example a relief-type surface, most of the particles would collect in depressions under the effect of gravity, or would get hung up on slanted side walls of ridges, but least of all on the top of ridges or other elevations, where they would be most easily visible. If uneven surface, nevertheless covered with anisotropic printing ink, are supposed to be produced, this is generally done in that first, the anisotropic color-shift ink is applied to the surface, which is still level, and subsequently the shape of the surface is changed by means of a mechanical effect, namely by means of an embossing process. For this purpose, a correspondingly structured embossing punch is pressed onto the surface, and an opposite punch is pressed against the back side of the object. This forming assumes that the object is sufficiently thin and formable. However, mechanical deformation is actually not necessary, since a planar printing ink layer composed of optically anisotropic printing ink as such already possesses a sufficient color-shift effect, based on the thin-layer particles.

Both methods for production of a color-shift effect, whether by means of a relief structure or by means of optically anisotropic ink particles, have in common that the resulting color change has mirror symmetry with reference to the surface normal line of the imprinted surface. A further commonality, in spite of different mechanisms, consists in that the imprint producing the color-shift effect has been produced by means of conventional printing techniques until now, in which a fixed printing plate is produced and used to carry out the imprint. The uniform printing plate ensures that on all objects, for example all labels, banknotes or other objects, the appearance of the color-shift surface, which serves as a security feature, is always identical within close tolerance limits, and can easily be checked for authenticity. Counterfeited or forged products, the color-shift surface of which was merely copied or counterfeited in some other manner, can easily be distinguished from authentic products, due to deviations as compared with the uniform appearance of color-shift surfaces on authorized products of the original manufacturer. As a result, it can be determined, for example, whether a label that has a color-shift field comes from the manufacturer, and whether the other imprinted information is authorized and accurate.

The present application pursues the opposite approach, namely the idea of configuring an imprint in such a manner that it can be variably structured, even though it is supposed to serve as an original reference object or comparison object for recognition of forgeries and, at the same time, as a color-shift surface.

It is therefore the task of the present invention to make available a method with which imprints structured as a color-shift surface can be printed onto the surface of objects, wherein the imprints can be structured in individually modified manner, in spite of their function as a reference object or comparison object (for example to distinguish between authentic and counterfeit products). For this purpose, a method that is as simple as possible, and is advantageous in terms of cost and time, is to be indicated.

This task is accomplished by means of the method according to claim 1.

According to claim 1, it is provided that a relief structure is formed, which is overprinted with a pattern of ink strips and thereby brings about a novel and individually variable color-shift effect. In this regard, at least the ink strips are printed by means of a digital printing technique. The ridges are preferably also printed by means of a digital printing technique, but alternatively can also be printed by means of a non-digital, i.e. a conventional printing technique. The non-digital printing technique can also comprise a step of embossing to form the relief structure.

In the case of the method according to claim 1, the color-shift effect occurs not by means of a color contrast between ridges of one color, formed entirely from the same ink, relative to a substratum of a different color, but rather by means of a color contrast of additional ink strips on top of and relative to the ridges, relative to which the ink strips are imprinted with an offset. The resulting color-shift effect generally does not have mirror symmetry with reference to the normal line direction of the imprinted surface, and above all it can be varied more flexibly than in the case of conventional color-shift surfaces, since on the one hand, exclusively digital printing techniques, without a printing plate, are used, but on the other hand, the use of anisotropic printing inks, in terms of color, which is conventionally usual, is circumvented.

According to claim 1, therefore, not just ridges are printed, but rather subsequently, at least first ink strips are also printed, specifically with a lateral offset relative to the ridges, wherein with the aid of the digital printing technique, a printing compound that is isotropic, in terms of color, is used to print the ridges, and a printing ink that is also isotropic, in terms of color, is used to print the ink strips. Suitable digital printing techniques are inkjet printing (inkjet printing), laser printing (electrophotography method) or thermal printing. Conventionally, in contrast, color-shift surfaces are produced, in terms of printing technology, by means of conventional techniques such as offset printing, flexographic printing or, above all, screen printing, in particular if they serve as a security feature for a great number of objects.

Using the method according to claim 1, it is possible to produce imprints that have a different type of color-shift effect than conventional color-shift surfaces, and which can be produced in individually varied manner, in spite of their function as a reference object or comparison object for tests of authenticity, without losing their suitability as a security feature.

Some exemplary embodiments, which can serve as examples, will be described below, making reference to the figures. These show:

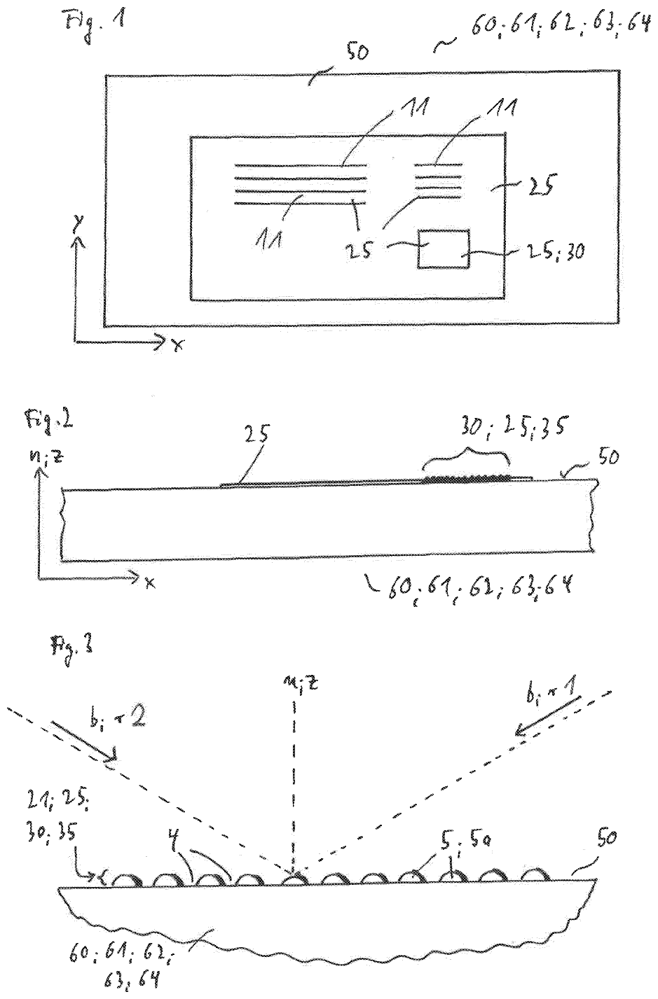

FIG. 1, a schematic top view of the surface of a label or other object, on which an imprint that serves as a color-shift surface, at least in certain regions, is configured,

FIG. 2, a cross-sectional view of the label or other object from FIG. 1,

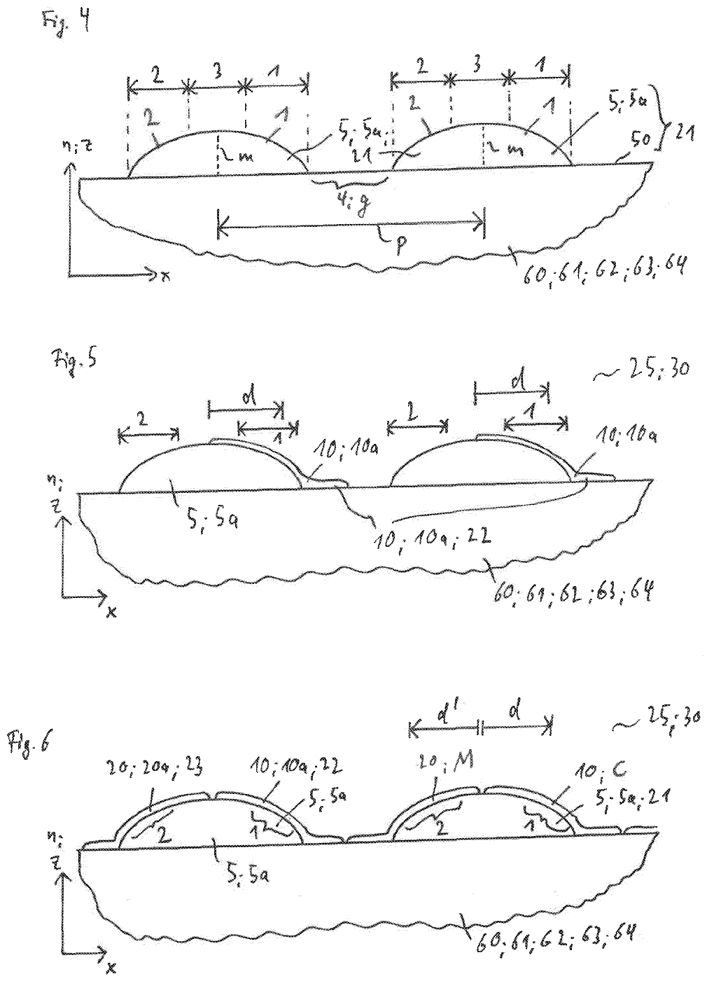

FIG. 3, a slightly enlarged cross-sectional view in comparison with FIGS. 1 and 2, in the region of the color-shift surface,

FIG. 4, a greatly enlarged detail view in comparison with FIG. 3, in accordance with the method step of printing a relief structure onto the surface of the object,

FIG. 5, a further detail view relating to the subsequent step of conformal printing of an ink strip pattern onto the relief structure,

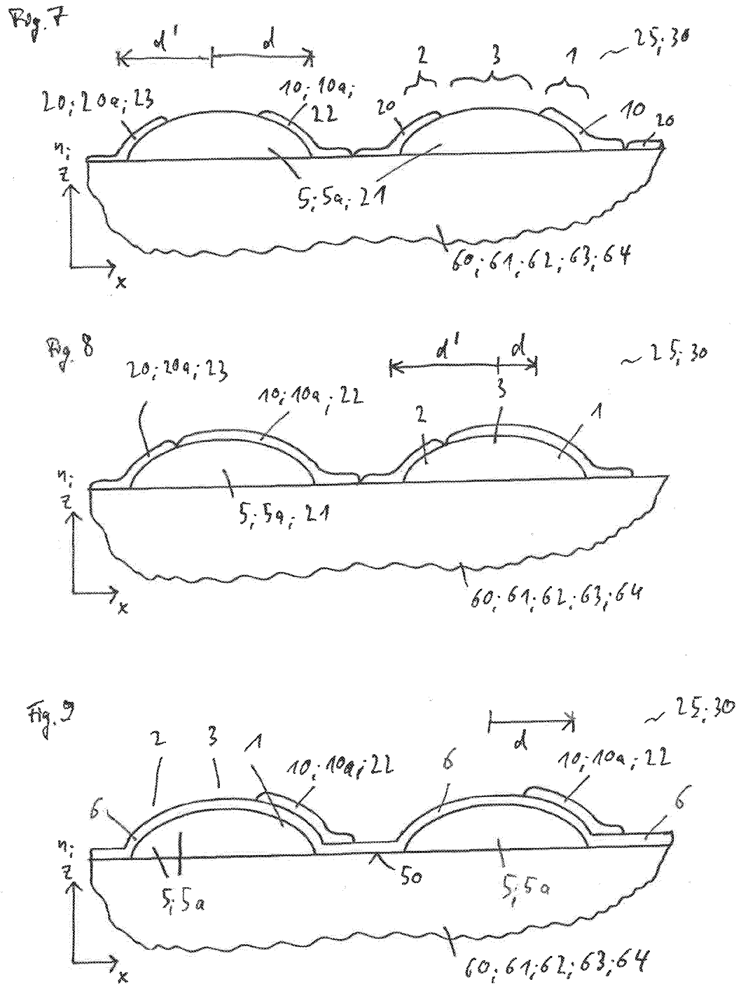

FIGS. 6 to 10, cross-sectional views to illustrate alternative exemplary embodiments with regard to conformal printing of one or more patterns of ink strips,

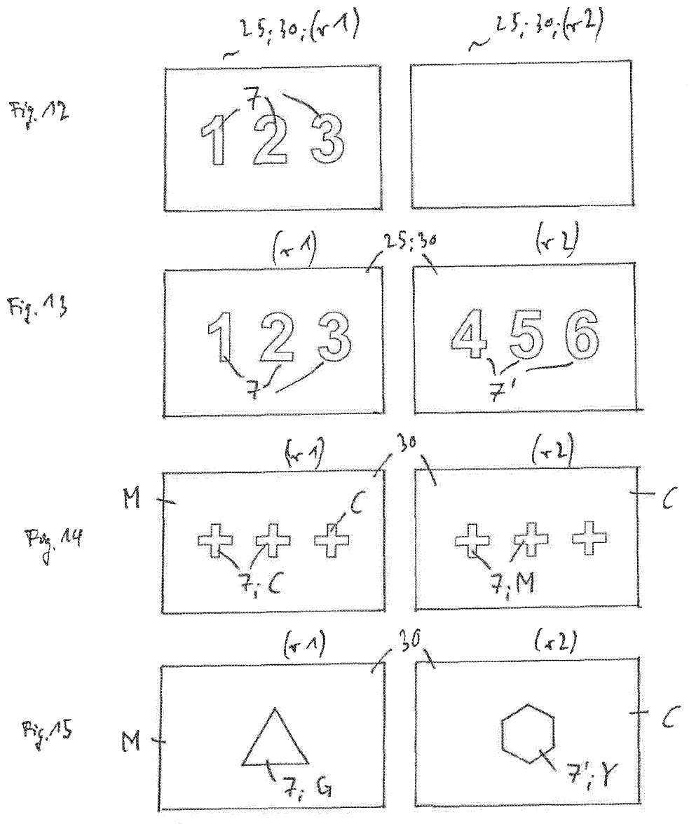

FIG. 11, an embodiment that has been developed further, in which ridges of a relief pattern that have been covered with ink strips run along two different directions,

FIGS. 12 to 17, different exemplary embodiments with regard to the distribution over the surface and the dependence of the viewing angle of color-shift imprints and/or motifs produced from them,

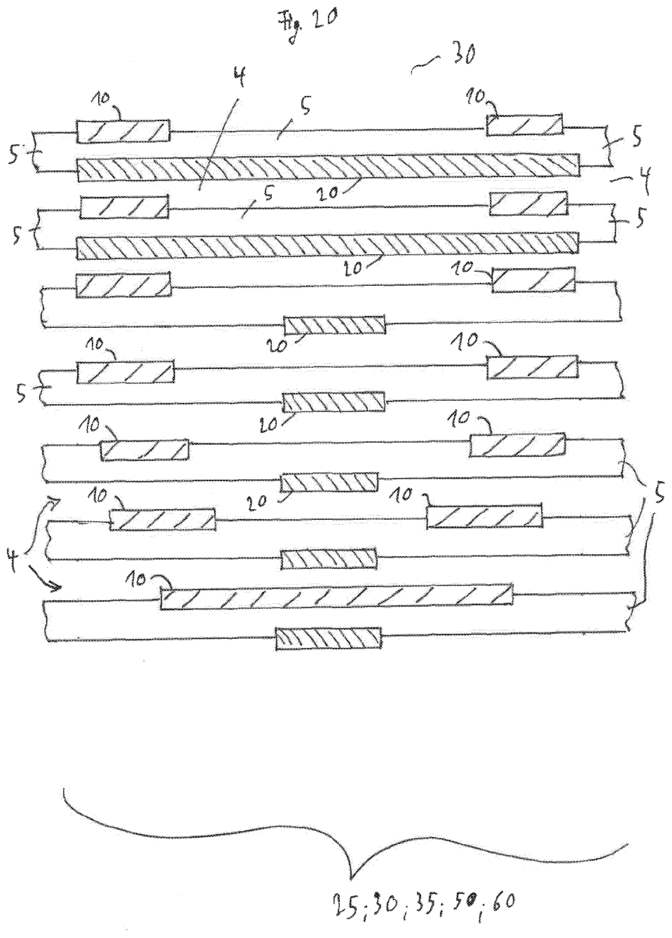

FIG. 18, an example of use of the color-shift imprint to be glued around the edge of an object,

FIG. 19, a set of objects of the same type, each sample of which is imprinted with an individually structured imprint, and

FIG. 20, a color-shift surface, as an example, having two visual color-shift motifs, structured independently of one another, which can be observed depending on the viewing direction.

FIG. 1 shows a schematic top view of a surface 50 of a label 62, of a banknote 63, of a printed material 61 or of another document 64 or object 60, which surface is to be imprinted in color-shift manner, in certain regions. The object 60 can also be a solid object, the back side of which is not accessible or is arranged too far removed from the surface 50 or front side to be imprinted. The object 60 can be, for example, a container for a chemical, a medication or some other solutions, preserved blood, liquid or for some other content that can be used medically or pharmaceutically. The object 60 can furthermore be a container for any desired materials, material compositions, substances, and products of whatever aggregate state, or alternatively, a label to be pasted onto such a container. The object 60 can furthermore be any desired product of daily life or having a specific technical or other use, or a precursor product or partial product for it. For the sake of simplicity, reference is made only to a label 62 hereinafter, also with reference to the further figures.

FIG. 2 schematically shows a cross-sectional view through the label 62 (or the other object 60) from FIG. 1, wherein the normal line direction n of the surface 50 to be imprinted corresponds to the vertical direction z, which runs perpendicular to the two lateral directions x, y, and, in the case of thin, planar objects such as labels, corresponds to the direction of the layer thickness. An imprint that possesses a color-shift effect is to be formed on the surface 50.

For this purpose, FIG. 3 shows a slightly enlarged cross-sectional view in the region of the color-shift surface. An imprint 25 is formed on the surface 50, comprising a relief structure 21 composed of a plurality of strip-shaped ridges 5, which are formed from a printing compound 5a or printing ink that is isotropic, in terms of color. The ridges 5 preferably all run parallel to one another and are at a distance from one another, preferably equidistant. The gaps 4 are surface regions of the surface 50 that have remained uncovered. In addition, ink strips are arranged on the right side flanks of the ridges 5, which strips are merely indicated in FIG. 3, but will be discussed in greater detail using FIGS. 5 to 11.

From the normal line direction n (FIG. 3), the surface 50 possesses a specific appearance (color, brightness, color saturation, reflectivity and/or further visual or wavelength-related properties), after completion of its color-shift imprint 25, which appearance is brought about by visual, in particular color-related melding of the ridges 5 and the gaps 4 between them, wherein here, the appearance of the imprint 25 or of a partial region of it, in the region of the relief structure 21, where the imprint 25 serves as a security feature 35, is of interest. Here, the imprint has the relief structure 21 with strip-shaped ridges 5, which cannot be resolved individually with the naked eye, or can be resolved only with difficulty.

Seen from a line of sight b in a slanted view relative to the surface 50, in contrast, the surface appears in a different color and/or brightness, etc., because now the rear side flanks of the ridges 5, seen from the line of sight b, are covered or appear only with a reduced width compared with the front side flanks of the ridges 5, seen from the line of sight b. In addition, however, the visual impression that the surface 50 leaves when viewed at a slant from a first viewing direction r1 is different from the visual impression of the same surface when viewed from the direction r2 that is its mirror opposite, even when undertaken at the same inclination angle relative to the surface, because one of the two ridge sides is covered with an ink strip of a different color (see below). For this purpose, different embodiments relating to an asymmetrical structure, in particular a color-related structure without mirror symmetry, of the outside of the ridges 5 are proposed below. Since the two side flanks of the ridges 5 of the relief structure 21 are configured differently, in terms of color, they change the overall color impression of the color-shift surface in different ways; a color transition between the viewing angles r1 and r2 occurs.

FIG. 4 shows the cross-sectional view from FIG. 3 in a greatly enlarged detail view in the region of two adjacent ridges 5. The surface 50 can be, for example, the surface of a label film or that of a layer or coating arranged on it, for example composed of a printed or printable varnish (for example in a single color or colorless), of a layer that influences adhesion (adhesive layer; anti-adhesion layer) or of another coating. In the simplest case, the surface 50 is a film surface or paper surface, if applicable, including the layer or coating arranged on it. Now, the imprint 25 is printed onto this surface 50, using the method according to the application, which imprint is structured, at least in certain regions, as a color-shift surface 30. The imprint 25 preferably also comprises other printed image components that do not serve as a color-shift surface, for example single-color (in particular black or white) or multi-color printed image components 11 (information provided as text or otherwise; test lines, images, graphic elements or motifs, bar codes or QR codes, etc.). These other printed image components 11 can also be printed within the scope of the method according to the use; for example during method step b) and c) (claim 4) or, alternatively, by means of an additional method step for printing a black or white background color or contrasting labeling without a color-shift effect. The (additional) printing of such further printed image components 11 takes place as in practically any known printing method; therefore only the production of the color-shift surface 30, which represents at least a partial surface or, in any case, a component of the entire printed image, in terms of printing technology, will be explained.

According to FIG. 4, a plurality of lines, more precisely stated of strip-shaped ridges 5, which run parallel to one another, is printed onto the surface 50.

Preferably, a digital printing method is used for printing the ridges 5, in particular inkjet printing (inkjet printing), laser printing (electrophotography printing) or thermal printing. In particular, it is preferably provided that printing of the ridges 5 is carried out using the same digital printing technique that is subsequently used (see below) also for printing ink strips. This makes it possible to print both the ridges 5 and the ink strips in one and the same printing machine.

Alternatively, however, printing of the ridges 5 can also take place by means of a non-digital printing method, and such a conventional printing method can also include an embossing method. However, this also holds true for printing the ridges 5, but not for printing of ink strips as will be described below.

Preferably, a white or light-colored (but isotropic) printing compound or ink is used to print the ridges 5; fundamentally, however, other printing inks can also be used. Preferably, the printing ink 5a is highly pigmented, i.e. provided with a high concentration of pigment, so that intensive colors can already be produced even when printing comparatively thin layers.

Alternatively, however, the printing compound 5a can also be configured to be colorless or, in any case, without any marked inherent coloration. Regardless of the color or coloring of the printing ink or printing compound 5a for printing the ridges 5, this printing ink or printing compound 5a is isotropic, in terms of color, in any case, and, in particular, is free of anisotropic particles, in terms of color.

The printing compound 5a (whether as a colorless printing varnish or colored printing ink) is printed, according to step a) of claim 1, as a relief structure 21 composed of a plurality of strip-shaped ridges 5 that project above the surface 50, i.e. are raised and preferably have a distance between them that remains the same. Gaps 4 having the gap width g remain between the ridges 5, where the uncovered regions of the surface 50 are exposed. Printing in step a) takes place at a ridge height of at least 30 μm, preferably at least 60 μm; however, the center lines m can also project above the surface 50 by 70 μm or even higher. In comparison with the distance p ([in English:] pitch distance) between ridge centers, the height of the ridges amounts to at least 7%, preferably more than 15% and, in particular, between 20 and 30%.

The ridges run along one and the same lateral direction y (here, perpendicular to the drawing plane of FIG. 4), and are arranged equidistantly along the other lateral direction x. Height, width, and cross-sectional profile of all strip-shaped ridges 5 are also identical within the scope of the production tolerances.

The ridges 5 possess two side flanks 1 and 2, which lie opposite one another, between which the uppermost center region 3 is arranged; the line of its highest elevation corresponds to the center line m. Due to the different orientation of the two side flanks 1, 2 of the ridges, the first side flanks 1 appear to be relatively wide when viewed at a slant—for example from the direction r1 of these flanks—whereas the second side flanks 2, which are in the rear from this direction, either appear to be narrowed or are covered by the ridge; this holds true, in particular, for greatly inclined viewing angles above 60° relative to the surface normal line of the surface. Although the first and second side flanks 1, 2 cannot be individually resolved with the naked eye, or this can be done only with difficulty, they nevertheless exert a differing influence on the overall color of the color-shift surface (which will still be completed subsequently) perceived as a function of the direction, because the uniform color impression that results from visual melding of the ridge contours (which still have to be covered with ink), is dominated by the side flanks that point closer to the observer and face him, in each instance.

Preferably, the printing compound 5a for the ridges 5 is printed onto the surface 50 by means of one-time printing, i.e. by means of a single printing step or pass through a single printing station (with a sufficiently thick printing ink application). Alternatively, the ridges 5 can be produced successively by means of two or more printing processes or passes through two or more printing stations, in other words in at least two partial layers, for example in order to achieve an even greater height of the ridges 5, above 100 μm. Optionally, printing of the ridges can also comprise in each instance an additional, immediately following whole-area overprint with a conformal printing layer (FIG. 10), in order to impart a suitable (contrast) color or other visual quality to the surface 50 and the ridge surfaces. However, the substratum color or visual background color must be differentiated from this, as will still be mentioned below under the aspect of image design of the color-shift surface as a whole for differentiation between motif and background; every motif color and every background color within a color-shift surface 30 structured as an image or graphics, etc., is composed of surface regions, namely of ridge center regions 3, first 1 and/or second ridge side flanks 2, and gaps 4 between the ridges, the colors of which meld with one another to produce the perceived color of motif or background. However, the resulting melded colors for motif and background are different and furthermore also changeable, depending on the viewing angle.

The above variants with regard to the configuration of the ridges can be combined with every exemplary embodiment of this application.

According to FIG. 5, after completion of the ridges 5 in step b) of claim 1, a plurality of ink strips 10 (first ink strips) is printed. The ink strips 10 possess a different color, brightness and/or visual, optical, wavelength-related quality and/or a quality that can be determined using measurement technology from the ridges 5 and the surface 50 underneath. Just as the ridges 5 (at least within the surface dimensions or inner and/or outer contours of the color-shift surface 30) of the relief structure 21 are printed parallel to one another and equidistant from one another, the ink strips 10 of which the pattern 22 printed in step b) consists are also printed parallel to one another (and to the ridges 5) as well as equidistant from one another (with the same period as the ridges). However, they are preferably printed to be conformal, i.e. as strip-shaped layer regions that maintain the height progression, increasing the height of the ridge surface, when covering it, approximately precisely as much as that of the gaps 4 between the ridges 5. Because of their different color, the ink strips 10 allow a two-color or multi-color design of the printed image 25 formed by the relief structure 21 and the pattern 22, which results in the color-shift surface 30 by means of visual melding of the colors of the ridges 5, ink strips 1, 2 and/or gap regions 4 with one another.

According to FIG. 5, it is provided that the ink strips 10 are printed not centered on or between the ridges, i.e. not with mirror symmetry onto or between the ridge centers or gaps, but rather asymmetrically with a lateral offset d relative to the ridges 10 or their center lines m. The offset d corresponds, for example, to the lateral offset of the center line of the ink strip 10 (centered between the two outer ink strip edges) relative to the center line m of the ridge 5 that is at least partially covered by the ink strip 10. Because the center or center line of the ink strip 10 is offset by this lateral offset d (according to FIG. 5, along the direction x), the ink strips 10 primarily or even exclusively cover the first side flanks 1 of the ridges 5, whereas they don't cover or only incompletely cover the opposite second side flanks 2.

As compared with conventional relief structures based on purely geometrical coverage, the ridges of which appear in one color on all sides, but contrasting to the gaps between them, the imprint 25 formed jointly by the ridges 5 and the ink strips 10 overprinted offset to them produces a color-shift surface 30 having a color-shift effect, which, although it is most strongly marked (as in the case of the above conventional relief structures) in a preferential plane perpendicular to the progression of the ridges, does not, however, have mirror symmetry relative to the surface normal line of the surface 50 in this preferential plane. In a slanted view r1 onto the first side flanks 1 (or onto the ink strips 10 printed onto them), the color-shift surface 30 as a whole appears in a different color or brightness, etc. than from the opposite viewing direction r2 onto the second side flanks 2. Even though the height of the ridges is relatively small in comparison with the ridge width and the distance between the ridges (gap width g), a color-shift effect that can be clearly perceived and reviewed can be implemented, since due to the structure, which does not have mirror symmetry, brought about by the lateral offset d, the angle range available for the color transition between two observable colors, brightness values or other visual properties that are maximally different from one another is twice as great as in the case of conventional relief structures.

In method step b), the first side flanks 1 do not have to be overprinted completely, i.e. not over the entire length of all the ridges 5, but rather, depending on the use, for example in the manner of a desired (first) color-shift motif, it can be provided, in particular, that selectively determined partial sections of the first side flanks 1, having a length that is shorter than the complete length of the corresponding ridge 5, are overprinted, and/or their positions along the length expanse of the ridge (perpendicular to the drawing plane of FIG. 5 ff.) can vary individually for every ridge, for a selection of ridges or in some other way. Preferably, the first side flanks 1 are selectively overprinted with these (first) ink strips 10 in those length sections of the ridges 5 that belong to surface regions of a motif or inverted motif that can be perceived from a first viewing direction r1, whereas in the remaining (first) surface regions or length sections of the ridges 5, their first side flanks 1 remain uncovered by the first ink strips 10. The first motif produced in this manner can then be observed and visually perceived from a first viewing direction r1, which is inclined relative to the surface normal line n of the surface 50, and which the side flanks 1 face.

At least in step b), it is provided that printing is carried out by means of a digital printing technique. As a result, the lateral dimensions, positions and/or contours, at least of the ink strips 10, can be predetermined variably, in particular changeably for every renewed printing of the printed image 25 structured as the color-shift surface 30, for example individually per unit for every individual imprint, i.e. for every copy of the printed image, which has a color-shift effect at least in certain regions.

Preferably, it is furthermore provided that also in step a), printing is carried out by means of a digital printing technique. As a result, the lateral dimensions, positions and/or contours of the ridges 5 can also be determined variably, in particular changeably upon every renewed printing of the printed image 25, structured as a color-shift surface 30, for example also individually per unit for every individual imprint.

Furthermore, it is preferably provided that an isotropic printing compound 5a, in terms of color (for the ridges) or printing ink 10a (for the ink strips 10) is printed in steps a) and b). Such printing inks possess no material-related, intrinsic color-shift properties, but rather bring about a color-shift effect only in combination with one another, in the case of a suitable lateral offset d between ink strips 10 and ridges 5.

This makes the use of color-shift inks that can be processed using embossing technology, having optically variable ink pigments, unnecessary. Since the same (specifically digital) printing method, for example inkjet printing, laser printing or thermal printing is used in both method steps a) and b) (and also in step c) according to claim 4), the ridges 5 and the first and second ink strips 10, 20 (see below) can easily be positioned relative to one another. The relative positions of ridges and conformal ink strips relative to one another, i.e. the lateral offset d; d′ between them (see below), can be precisely established in digital manner and can furthermore be varied individually, in particular individually per unit, in the case of every individual, renewed imprint.

Some alternative exemplary embodiments with regard to overprinting of the first and/or second side flanks 1, 2 of the ridges 5, starting from step b), will be described below, making reference to FIGS. 6 to 11.

According to FIG. 6, it is provided that the method additionally comprises a step (step c) according to claim 4) of conformal deposition of a further pattern 23 composed of further second ink strips 20 (also composed of isotropic printing ink 20a), so as to overprint the surface regions of the ridges 5 that were not covered by the previous ink strips 10, in particular their second side flanks 2 (the previous conformal ink strips 10, which were printed first, will be referred to as first ink strips 10 hereinafter). In this regard, the second side flanks 2 do not need to be overprinted completely, i.e. not over the entire length of all the ridges 5, but rather, depending on the use, for example according to the type of a desired (second) color-shift motif, it can particularly be provided that selectively determined partial sections of the second side flanks 2 are overprinted, the length of which is shorter than the complete length of the corresponding ridge 5 and/or the position of which, along the length expanse of the ridges (perpendicular to the drawing plane of FIG. 5 ff.), can vary individually for every ridge, for a selection of ridges or in some other way. Preferably, the second side flanks 2 are selectively overprinted with these second ink strips 20, in those length sections of the ridges 5 that belong to surface regions of a motif or an inverted motif that can be perceived from a second viewing direction r2, wherein in the remaining (second) surface regions or length sections of the ridges 5, their second side flanks 2 remain uncovered by the second ink strips 20. The second motif produced in this way can then be observed or visually perceived from a second viewing direction r2 that is inclined relative to the surface normal line n of the surface 50, which the second side flanks 2 face.

The design of the second motif, produced using the second ink strips 20, in partial sections of the second side flanks 2, or at least visually influenced, determined and/or dominated by them, in terms of color or some other way (for example an image motif, written motif or a motif serving as a security feature), can be selected independent of the design of a possible first first motif formed from the first ink strips 10. In particular, such a second motif does not necessarily have to represent a first motif that is merely contrast-inverted, color-inverted or otherwise inverted (or its complementary or inverted counter-motif). In particular, if both a first motif (using the first ink strips 10) and a second motif (using the second ink strips 20) are supposed to be produced, a first selection of ridges can have corresponding length sections (in a direction perpendicular to the drawing plane in FIG. 5 ff.), in which not only is the first side flank 1 overprinted with the corresponding first ink strip 10, but also the second side flank 2 is overprinted with the corresponding second ink strip 20 (printed side flanks on both ridge sides; i.e. ridge sections overprinted on both sides), and/or a second selection of ridges can have corresponding length sections in which neither is the first side flank 1 overprinted with a first ink strip nor is the second side flank 2 overprinted with a second ink strip (uncovered side flanks on both ridge sides; i.e. ridge sections not printed on both sides).

The second ink strips 20 possess a color, brightness or other visual quality that contrasts with or at least is different from the first ink strips 10, for example. For example, the color of the first ink strips is cyan C and that of the second ink strips 20 is magenta M, but any desired two individual colors can be chosen for the first and second ink strips 10, 20, that are supposed to meld within the color-shift surface 30 to form an overall color that changes as a function of the line of sight. The second ink strips 20 can optionally be printed with or without a lateral offset d′ relative to the ridges or their center lines; preferably, printing takes place with an established offset d′ that is different from the period or half-period of the relief structure 21. Here and in all the other figures and other embodiments of the applications, the regions of the surface 50 between the ridges 5 that have remained planar can optionally also be printed with the first and/or second ink strips 10; 20 (either only in certain regions or completely) or can remain unprinted, depending on the desired color distribution over the width dimension x of the color-shift surface 30. According to FIG. 6, in a top view only the color surfaces in cyan C and magenta M can be seen; when looking from the side, depending on the line of sight, either the color cyan or magenta predominates more or less, and thereby different color impressions can be produced (in general, however, the direction-dependent mixed color composed of two individual colors is different from them, in each instance; a mixed color cyan does not require that either the first or the second ink strips must be cyan in color). The color-shift effect of the imprint 25; 30 occurs by means of tilting or pivoting the surface 50 of the object 60 back and forth about an axis parallel to the lines of the line structure; the structures 5, 10 and/or 20 of the imprint were printed by means of inkjet printing, laser printing or some other digital printing method.

Preferably, the distance between adjacent ridges 5 is selected to be as small as possible, but large enough so as to prevent adjacent ridges or contrasting ink strips deposited on them from running into one another and unintentionally melding. The entire color space of the digital printing technology being used, for example composed of the process colors CMYK or another color system, is available for configuring the color-shift surface. In particular, UV-curable inkjet printing inks or printing inks can also be used. All overprinting of the surface to be undertaken one after the other, at first by means of the ridges 5 and then by means of one or more different, in particular differently colored strips 10, 20, etc. can take place with a slight time offset, one after the other, in particular in passing through multiple printing stations of one and the same printing machine, arranged one behind the other; the great register accuracy when using the same digital printing method such as inkjet printing, for example, for all the printing steps allows precise control of the intended color-shift effect.

Although specific colors for the corresponding ink strips, for example a first color for the first ink strip 10 (for example cyan), a second color for the second ink strip 20 (for example magenta) or optionally, a third color for a third ink strip (see below) are mentioned in this application, this does not necessarily mean that spot colors, i.e. ready-mixed, pure and homogeneous printing ink compounds having the desired color impression of the first, second and/or third ink strip must be used for the corresponding ink strips of the pattern 22, 23, etc., in question. Alternatively, each pattern of the same kind of ink strips, simultaneously printed by means of the same method step, can also consist of a pixel pattern or print dot pattern, wherein the color composition and the mixing ratio of the corresponding print dots (particularly those having different colors), which make up an ink strip, is such that all the first ink strips 10 as a whole (by means of visual melding of the colors of all the print dots involved) yield precisely the intended first color of the pattern 22. The same holds true analogously for the second and, if applicable, third ink strips 20 and 12 printed subsequently, which also do not have to be ready-mixed spot colors. Whether the ink strips are printed as print dot patterns composed of spot colors or as a print dot pattern composed of print dots composed of multiple different basic colors C, M, Y, K depends on the configuration of the printer of the digital printing method.

In addition to or in place of spot colors or different basic colors C, M, Y, K (for melding of differently colored print dots to produce the desired strip color), special inks can furthermore be used to form the ridges and/or ink strips, as long as they can be printed using the corresponding digital printing technique, for example, safety inks having further effects, for example fluorescent inks, infrared inks, inks for marking (taggants), as well as special inks that shimmer or shine in silver or different colors, for example for a pearly shine, etc. The color-shift effect can, in particular, also be observed in the UV or infrared range, for example.

The desired color-shift effect can furthermore be controlled by the geometry of the relief structure 21; for example, the height of the ridges, which is essentially determined by the relief structure that is formed in step a), can be selected to be between 40 and 100 μm, preferably between 60 and 70 μm. The distance p ([in English:] pitch distance) between ridge centers of the ridges 5 from one another can be selected to be between 150 and 400 μm, in particular between 250 and 350 μm, for example. The proportion of the distance p between ridge centers can amount to between 60 and 85% of the distance p between ridge centers. However, even very narrow ridges can be formed at a great distance from one another, for example ridges having a width of 100 μm and with gaps having a gap width g of 300 μm. First and second ink strips 10; 20, each having a width of 200 μm, i.e. approximately half the distance p between ridge centers, can be printed onto this pattern. In this regard, the relief height can amount to 50 μm, for example. Furthermore, any desired combinations of two, three or even more different colors in the form of colored ink strips 10, 20, 12, . . . can be combined with one another in the part of the print image 25 that is structured as a color-shift surface 30.

As has been mentioned, the color-shift effect can also be observed or measured outside of the visible spectrum, for example with the aid of fluorescent inks, infrared inks, up-converters, etc. (see above). The term color-shift effect and of “color” of the corresponding ink strips (and, if applicable, the ridges 5) therefore also includes qualities and properties of the corresponding isotropic printing inks 5a, 10a, 20a that are wavelength-related or spectrum-related, if applicable that can only be determined using measurement technology, which can only be detected with the aid of additional illumination (UV, IR) or measurement devices. As a result, even hidden security features can be implemented as a function of angle by means of the imprint 25. For example, a standard color (CMYK process color) can be used for the first ink strips 10, and a fluorescent color can be used for the second ink strips 20, or vice versa, so that the color impression of the color-shift surface that is dominated by the standard color under normal daylight or interior light contrasts with the color impression dominated by the fluorescent color under UV light. Furthermore, inks that appears to have a different color under infrared light can be used, for example in that the first ink strips 10 composed of a pigment-based printing ink for infrared-transparent black (black free of carbon black; “[in English:] photo black”) is used, but for the second ink strips 20, a pigment-based printing ink that yields an infrared-absorbing black (black that contains carbon black; “[in English:] pigment black”) is used. While the strip pattern on the relief structure formed in this way looks black under daylight or normal interior light, a shift effect can be observed in the near infrared range, using an infrared camera, for example, because depending on the line of sight, an infrared-reflecting relief line that appears white or at least light in color becomes visible through the space between two infrared-absorbing lines that appear black or at least dark.

The color-shift surface, formed from ridges and ink strips, can be refined or coated with transparent varnish in a final step, for mechanical protection and to increase the degree of gloss.

All of the characteristics of the respective embodiments described up to this point can be combined both individually and in combination with one another with each of the figures and further embodiments that will still be described below; for this reason, repetition will be refrained from.

FIGS. 7 to 11 show further alternative embodiments, shown in cross-section, with regard to the number of types of differently colored ink strip patterns, the width of their ink strips and their positioning relative to the ridges. In FIG. 7, the second ink strips 20 are arranged with mirror symmetry relative to the first ink strips 10, but are formed from a printing ink 20a that contrasts with them. The center regions 3 of the ridges 5 remain uncovered, so that the first and second ink strips 10, 20, respectively, only cover the first or second side flanks 1; 2 or outer, strip-shaped sections of them; if applicable, also the gaps between the adjacent ridges 5.

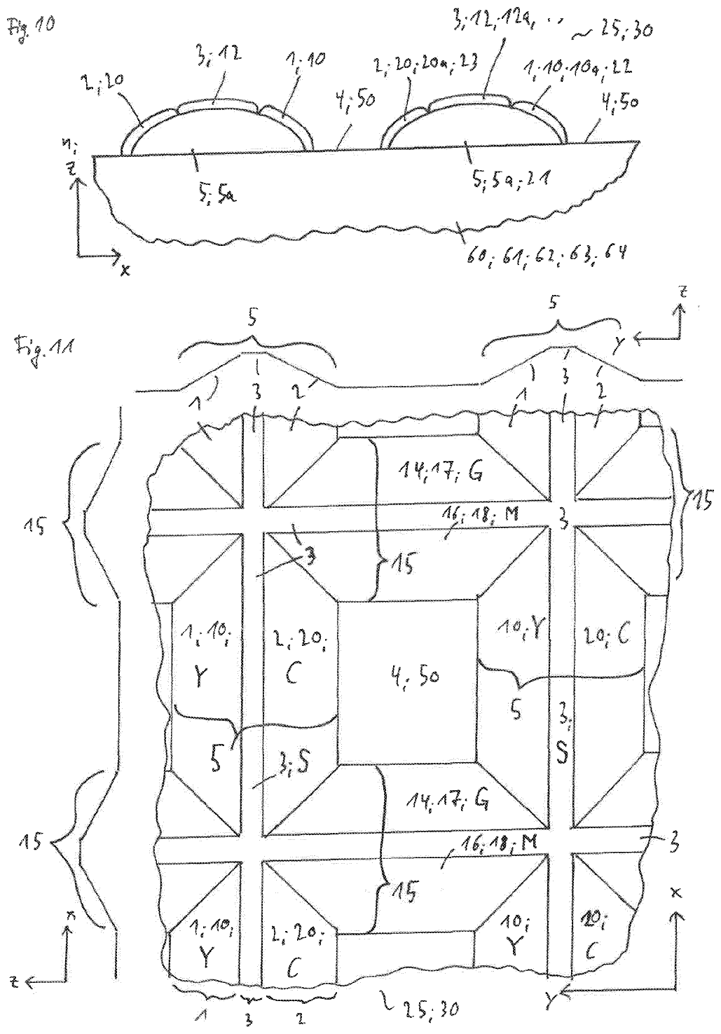

Alternatively, according to FIG. 8, the ink strips are printed onto the ridges in such a manner that the first ink strips 10 cover both the first side flanks 1 and the center regions 3, whereas the second ink strips 20 only cover the second side flanks 2.

According to a modification shown in FIG. 9, which can be combined with any other drawing or embodiment, a contrast layer 6 is printed onto a printing ink that is also isotropic and demonstrates color contrast, in the region of the color-shift surface 30, over the full area, between steps a) and b), i.e. immediately after printing of the ridges 5, before the first ink strips 10 (printing ink 10a) are selectively printed onto preferably one of the two side flanks 1 of the ridges in step b).

Furthermore, according to FIG. 10, third ink strips 12 of a third, also isotropic printing ink 12a can be printed in addition to the first and second ink strips 10, 20, with their color differing from that of the first and second ink strips 10, 20. In this way, three-color (or, if the strip-shaped gap regions 4 of the surface 50 are left out, also four-color) color-shift surfaces can be produced by means of printing technology, which surfaces are composed of strips having different colors. For example, the center regions 3 are only covered by the third ink strips 12 when these are subsequently printed, and thereby a third pattern 13 occurs on the top of the ridges.

In this manner, the surface of the ridges 5 of the relief structure 21 can be divided into three print zones, for example, which correspond to the first side flanks 1, the center regions 3, and the second side flanks 2.

In FIG. 10 and the other embodiments, the different imprinting of two, three or more differently structured surface regions 1, 2, 3 of the ridges can also be utilized to represent a motif having a spatial 3D impression, wherein advantage is taken of the fact that due to the eye distance between the right and left eye and the usually slight viewing distance, the two eyes are directed at the ridges of the relief structure from slightly different directions, wherein, for example, the right eye perceives a first image dominated by the imprints of the first side flanks 1 (for example by the first ink strips 10), whereas the left eye perceives an image dominated by the imprints of the second side flanks 2 (for example by the second ink strips 20). If the two images are such that although they are different but correspond to views from different directions, the impression of spatial depth of the superimposed overall image occurs. Conventionally, such effects can only be implemented as a lens raster image with specially prepared lenticular films having a significantly greater material thickness above 300 μm. According to FIG. 10, such a spatial image effect can be refined by means of providing three different surface regions or print zones.

FIG. 11 shows a further development in which not only first ridges 5 that run parallel to one another but rather (for example at a right angle to them) additional second ridges 15 are configured on the surface 50 of the object, wherein the first ridges 5 intersect and cross them. Each type of ridges 5; 15 is covered with ink strips, in such a manner that different color-shift effects can be observed in both groups or running directions of ridges 5; 15. In this regard, a top view of four intersection points of the first 5 and second ridges 15 is shown in FIG. 11 as a detail view, together with two cross-sectional views perpendicular to the lateral directions x and y. The (schematically simplified) height profile of the corresponding ridges 5; 15 becomes evident from the latter; their side flanks 1, 2, 14, 16, which run at a slant to the surface 50, can possess the following colors, named in the top view.

The surface 50 remains unchanged in color in the gap surfaces 4 not covered by the ridges, which surfaces are square or rectangular here; their color can be, for example, black or white or some other additional color that deviates from those of the ridge side flanks. The first ridges 5, which run vertically in the top view, possess first side flanks 1, which bring about a color effect of the overall color-shift surface 30 as yellow (Y; [in English:] yellow) when viewed at a slant approximately from their normal line direction, whereas the overall color impression of the color-shift surfaces from the viewing direction approximately perpendicular to the second side flanks 2 is predominantly influenced by the second side flanks 2 and the second ink strips 20 arranged on them, and thereby a color impression as cyan (C) occurs, for example. The color transition between them corresponds to a change in the viewing direction within the yz section plane (at the top in FIG. 11). When changing the viewing direction within the xz section plane (on the left in FIG. 11), in contrast, the color impression changes between green (G; brought about by the first side flanks 14 of the second ridges 15, which are preferably formed by ink strips 17 composed of green printing ink G) and magenta M (brought about by the second side flanks 16, which are overprinted with second ink strips 18, which bring about a magenta-colored overall impression). In this way, different color-shift effects can be implemented along different directions x, y, by means of one and the same color-shift surface 30. Furthermore, each color-shift effect does not have mirror symmetry with reference to the corresponding section plane, something that cannot be achieved with conventional relief patterns. Here, too, other direction-dependent optical effects (for example in the UV or infrared range; see above) can be combined in place of visual color transitions in the visible spectrum.

The production of special color-shift surfaces 30 by means of printing technology, as proposed in this application, can be used, among other things, for implementing motifs 7 that become visible or invisible, depending on the viewing angle. FIGS. 12 to 17 show some exemplary embodiments in this regard. In FIGS. 12 to 15, the color-shift surface is shown twice, in each instance, specifically once viewed in a slanted view from the direction r1 onto the first side flanks 1 (shown on the left in FIGS. 12 to 15), and once viewed from the viewing direction r2, also at a slant but oriented with mirror symmetry relative to the normal line direction, approximately from the direction of the opposite side flanks 2. In FIGS. 12 to 17, once again a relief pattern having only a single running direction of ridges is used as the basis, as was already done in FIGS. 3 to 10.

According to FIG. 12, a motif 7, here consisting of a three-digit sequence of numbers, appears from the first viewing direction r1 (inclined, for example, at an angle of greater than 45°, preferably greater than 60° relative to the surface normal line of the surface 50), whereas no motif can be seen from the mirror-image viewing direction r2. The entire surface 30 that is shown demonstrates color shift, but optionally only the motif 7 or only its surroundings can do so.

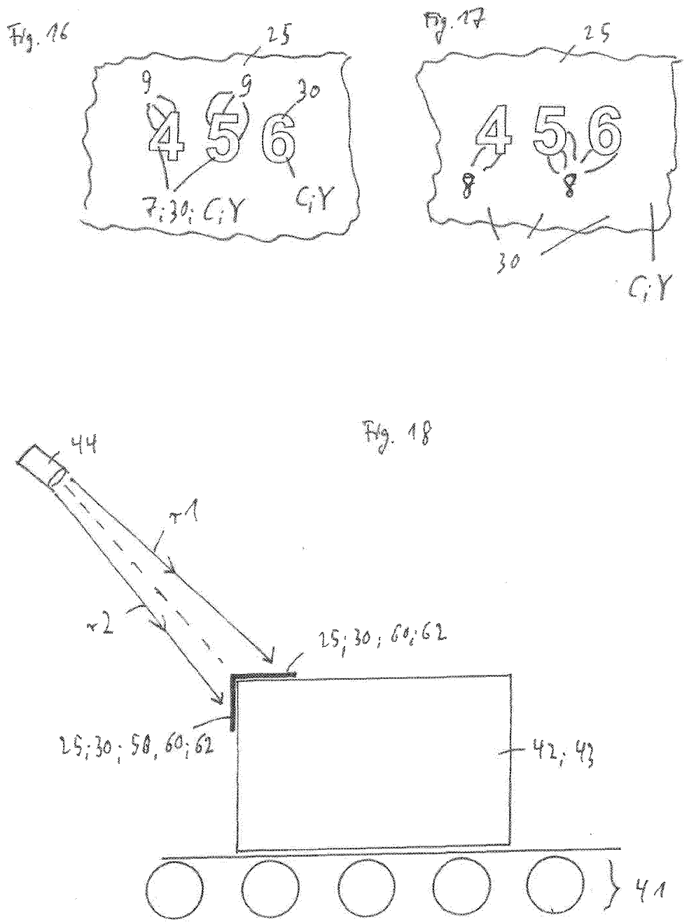

Alternatively, according to FIG. 13, a different motif 7 or 7′ can appear, depending on the viewing direction r1, r2; furthermore, motif color and background color (of the surface surrounding the motif, which is interpreted as a background color in terms of image design) can be switched or otherwise appear differently at the viewing angles r1, r2.

Furthermore, according to FIG. 14, one and the same motif 7 can appear to be positioned the same or dimensioned the same as compared with the motif background surface, from the two viewing directions r1, r2, but with changing colors for motif 7 and background, in each instance. For example, from the first viewing direction r1, the motif 7 (here in cross shape) appears in the color cyan C against a magenta-colored background M, whereas from the second viewing direction r2, the motif appears in magenta M against a cyan-colored background C. For example, in the surface regions of the motif 7, the first ink strips 10 can cover the first side flanks 1 of the ridges 5, and the second ink strips 20 can cover the second side flanks 2 of the ridges 5, whereas in surface regions of the image background, the first ink strips 10 cover the second side flanks 2 of the ridges 5 and the second ink strips 20 cover the first side flanks 1 of the ridges 5. In this way, the motif is differentiated from the background by means of an inverted color-shift effect that changes in its direction.

FIG. 15 combines the color switch of motif and background with the provision of different motifs 7; 7′ for the two directions r1, r2.

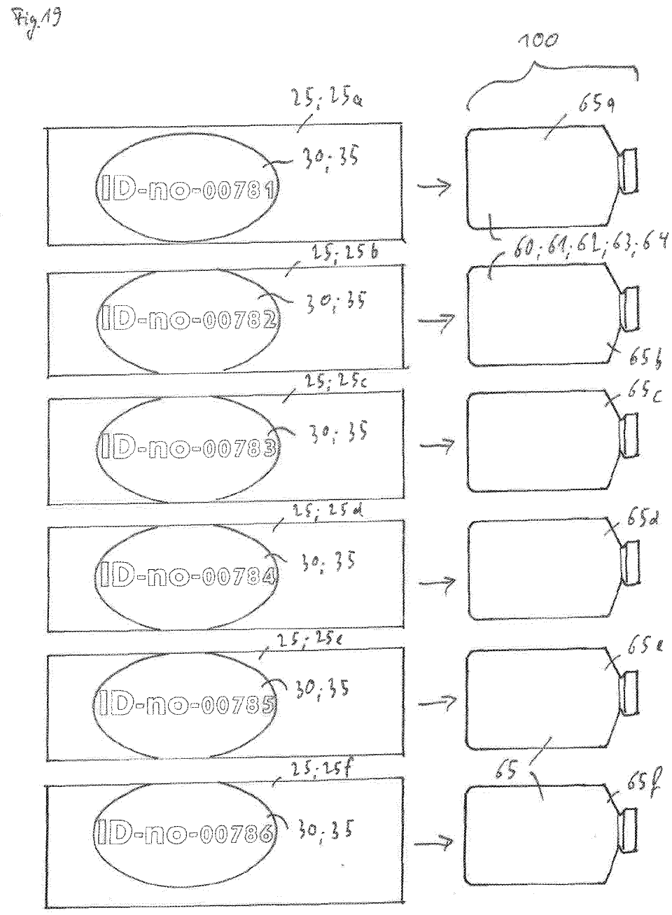

According to FIG. 16, the color-shift surface 30 itself can also be configured as a motif 7, on the basis of its outer contour 9, as compared with a non-color-shift background or a non-color-shift surface region of the imprint or of the print image 50; for example as shown, as a three-digit character sequence, wherein the outlines of each of the alphanumeric characters simultaneously represents an outer contour 9 of the color-shift surface 30 or of a partial color-shift surface 30. The alphanumeric characters, which are preferably printed with a sufficiently great character height of at least 12 or 14 pt, in bold and/or in a sans serif font, appear as the colors C and Y (cyan and yellow), for example, depending on the line of sight, whereas the surrounding surface regions can possess any desired color (including white, black, gray, etc.), but not a color-shift, i.e. direction-dependent color.

Alternatively, according to FIG. 17, the motif can also be implemented by means of an inner contour 8 of a color-shift surface 30, wherein the inner contour 8 can simultaneously form a motif 7 and consists, for example, of one or more recesses of the color-shift surface region 30, here, for example, in the form of one or more alphanumeric characters. As a result, only the surface surrounding them is configured as a color-shift surface, for example alternating between the colors C and Y.

FIG. 18 illustrates a potential use of color-shift imprints 25 produced according to the application, which can be implemented by means of the color-shift effect of the relief pattern, which no longer has mirror symmetry. According to FIG. 18, a label 62 is affixed onto any desired object 42, for example a product or its packaging 43, in such a manner that it is glued around an edge of the product or its packaging, and thereby the orientation of the label surface changes within the label surface. The outside of the label 62 is provided with an imprint 25, which is configured as a color-shift surface 30. On a first surface of the product 42 or its packaging 43, the label surface that has been glued on faces upward, for example, with its normal line direction n, whereas on the other side of the edge around which it is glued, the normal line direction of the color-shift surface 25; 30; 50 of the label faces in a different direction, for example at a right angle to the former, in FIG. 18 horizontally to the left. If the glued-on label is monitored and filmed using a video camera 44, for example, the line of sight r1 approximately corresponds to the viewing direction at a slant onto the first side flanks of the ridges in a partial section of the label surface, wherein in a different label section on the opposite side of the bent edge of the label, the viewing direction r2 there corresponds to a slanted view onto the opposite, second side flanks of the ridges on the top of the label. The more parallel the ridges of the label 62 run relative to the edge of the packaging or to the bending line of the label (in FIG. 18, ideally perpendicular to the drawing plane), i.e. the smaller the angle between the ridges and the edge around which the label is glued, the better this effect works.

Since the label 62 is a color-shift label, the first label section appears as cyan to the camera 44, for example, while the second label section, which has a different orientation, appears in a contrasting color such as yellow, for example. This can be utilized for automatic detection of the position of the packaging on a transport belt 41, as shown.

Furthermore, simply by gluing the imprinted label around the edge of an object, a self-aligning, self-adjusting color change of the label occurs relative to the bending line or the edge around which the label was glued (for example on outer edges of any desired objects 42 or packaging 43), and thereby the bending edge of the label 62 automatically appears to the human eye (conceptually in the same position as the video camera 44 in FIG. 18) as a color boundary between two color impressions C, Y of the label, although in terms of printing technology, no kind of color edge, color transition or color contrast is implemented between the two sections of the label, because the label as a whole is a color-shift label, but the color-shift design is homogeneous over the entire label surface or, in any case, over its color-shift surface, without two different types of color-shift surface regions being required to be glued onto the two sides of the edge around which the label is glued. In place of a label, any printed material that can be glued or has been glued around an edge, for example a closure seal, can also be structured to be self-aligning in this manner; during dispensing onto the product, the packaging or onto the other object, the color boundary always runs along the edge of the object, even without adherence to a specific positioning accuracy. Depending on the line of sight relative to the edge, the two partial surfaces or partial sections of the label or other printed material can appear in similar or in greatly contrasting colors (for example C, Y), depending on the viewing angle of 60°, 45° and 30° relative to the surface of one of the two label sections, for example. Conventional labels, in contrast, must be printed in two different colors and the color boundary must be placed precisely onto the edge of the packaging or other object; this adjustment effort is eliminated by means of the color-shift label that does not have mirror symmetry.

FIG. 19 shows a set 100 of printed materials 61, labels 62, banknotes 63 or other similar documents 64 or objects 60, of which a plurality of specimens 65 are included in the set 100. As an example, a set of vials or ampoules for medication solutions is shown, having circumference surfaces onto which elongated labels are to be glued or directly imprinted. Each specimen 65 or 65a, . . . , 65f of the vials or other objects is to be imprinted or otherwise covered with an imprint 25a, . . . , 25f, in each instance, which is structured as a color-shift surface 30. Each imprint 25 comprises a color-shift surface 30 that first of all serves as a security feature 35, but here, in addition, has an individual marking function. The color-shift surface 30 of each specimen of the imprint 25a is different from the other ones 25b, . . . , 25f, and after being printed onto the objects 60 (or onto labels 62 intended for this purpose), each specimen of the objects 65a, . . . , 65f is individually marked, since the imprints 25a, . . . , 25f are configured to be similar to one another but different from one another. Instead of vials, the objects can also be printed materials 61, labels 62, banknotes 63 or other documents 64. After imprinting or dispensing with the aid of labels, this later allows identification, tracking, back-tracking, authentication and/or other marking of each individual specimen 65a; . . . ; 65f of these objects. The individual markings can be alphanumeric character sequences printed in color-shift manner, for example, the outer contours, inner contours or motif/background contrast lines of which have been printed in the form of an individual alphanumeric or other marking, in each instance. Furthermore, the angle-dependent color appearance of the motif or of the other individual marking can also be configured in individually modified form for every specimen 25a, . . . , 25f of the imprint 25. In this way, a set 100 of similar specimens of printed materials, labels, banknotes or other similar documents or objects 60 occurs, each of which is printed or covered in color-shift manner in certain regions, wherein the corresponding color-shift surface 30 on every object is individually modified per unit.

FIG. 20 shows a color-shift surface 30, as an example, which is produced by means of the method described in this application and has two visual color-shift motifs 7, 7′ that are structured independently of one another and can be observed as a function of the viewing direction, as has already been illustrated using the above figures, in particular FIGS. 13 and 15. FIG. 20 shows an enlarged detail view, in which the corresponding ridges 5 and gaps 4 between them can be seen.

In FIG. 20, a first color-shift motif 7, as an example, is implemented by means of the first ink strips 10, which cover only the first side flank 1, facing upward, of the corresponding ridge 5, in each instance facing upward in FIG. 20; the related outlines of the first ink strips 10 (shown greatly enlarged here) visually meld to form a capital letter “U” when viewed with the naked eye, which letter contrasts in terms of color or in some other way relative to the surrounding surface regions, in which the ridges 5 or ridge sections do not have any first ink strips on their first side flanks 1. The contrast between this first color-shift motif 7 relative to its surroundings is greatest from the first viewing direction r1, for example (see FIG. 3); viewed from the second viewing direction r2, in contrast, this motif 7 cannot be perceived or can hardly be perceived.

Furthermore, in FIG. 20 a second color-shift motif 7′ is implemented as an example, by means of the second ink strips 20, which cover only the second side flank 2 of the corresponding ridge 5, facing downward in FIG. 20, in each instance; the related outlines of the second ink strips 20 visually meld to form a capital letter “T” when viewed with the naked eye, which letter contrasts in terms of color or in some other way relative to the surrounding surface regions, in which the ridges 5 or ridge sections do not have any second ink strips on their second side flanks. The contrast between this second color-shift motif 7′ relative to its surroundings is greatest from the second viewing direction r2, for example; viewed from the first viewing direction r1, in contrast, this motif 7′ cannot be perceived or can hardly be perceived.

Here, too, the second color-shift motif 7′ is not a motif that is simply inverted as compared with the first color-shift motif 7, but rather can be designed completely independently of it and can therefore assume surface dimensions and outlines (here, for example, in the form of the letter T instead of U) that can be selected completely independently. In this regard, a first selection of ridges 5 can have corresponding (first) length sections in which not only is the first side flank 1 overprinted with the corresponding first ink strip 10, but also the second side flank 2 is overprinted with the corresponding second ink strip 20, in FIG. 20, for example, the left and right region of the uppermost two ridges and the center of the lowermost ridge. Alternatively to this or in addition, a second selection of ridges 5 can have corresponding (second) length sections in which neither is the first side flank 1 overprinted with a first ink strip nor is the second side flank 2 overprinted with a second ink strip; in FIG. 20, these are the lateral interstices between the vertical bar of the capital letter “T” and the two vertical arms of the capital letter “U”.

Such a color-shift surface 30, as it is illustrated as an example in FIG. 20, is not subject to any kind of restrictions with regard to the area-related design of the two color-shift motifs 7; 7′ (which can be observed from different directions r1, r2); the color-shift motifs 7; 7′ therefore do not need to be inverted or complementary to one another. Furthermore, each color-shift motif 7; 7′ can also be perceived only from one of the two predetermined viewing directions r1, r2; the color-shift effect for each color-shift motif therefore does not have mirror symmetry with reference to the normal line direction n of the printed surface 50 (perpendicular in FIG. 3). Furthermore, only a single color-shift motif 7 or 7′ needs to be implemented, as has already been explained using the example of FIG. 12.

### REFERENCE SYMBOL LIST

1 first side flank
2 second side flank
3 center region
4 gap
5 ridge
5a isotropic printing compound
6 contrast layer
7 first color-shift motif
7′ second color-shift motif
8 inner contour
9 outer contour
10 first ink strip
10a isotropic printing ink
11 printed image portion
12 third ink strip
12a isotropic printing ink
13 pattern
14 first side flank
15 second ridge
16 second side flank
17 first ink strip
18 second ink strip
20 second ink strip
20a isotropic printing ink
21 relief structure
22, 23 pattern
25; 25a, 25b, 25c imprint
30 color-shift surface
35 security feature
41 transport belt
42 object
43 packaging
44 video camera
50 surface
60 object
61 printed material
62 label
63 banknote
64 document
65 specimen
100 set
b line of sight
C cyan
d; d′ offset
g gap width
G green
m center line
M magenta
n normal line direction
p distance between ridge centers
r1 first viewing direction
r2 second viewing direction
S black
x first lateral direction
Y second lateral direction
Y yellow
z vertical direction

1: A method for printing an imprint (25), which is structured as a color-shift surface (30), at least in certain regions, onto the surface (50) of at least one object (60),
wherein the method comprises at least the following:
a) printing a relief structure (21) having a plurality of strip-shaped ridges (5) onto a surface (50) of at least one object (60), wherein the strip-shaped ridges (5) are raised relative to the surface (50) and at a distance from one another, and each have a first side flank (1) and a second side flank (2), and
b) conformal printing of a pattern (22) having a plurality of first ink strips (10) parallel to the ridges (5), but with a lateral offset (d) relative to the ridges (5), whereby the first ink strips (10) determine the color, brightness and/or another visual, optical or wavelength-related property more strongly at a slanted view from the direction of the first side flanks (1) and at a slanted view from the direction of the second side flanks (2), wherein at least in step b), printing is carried out by means of inkjet printing, laser printing or another digital printing technique, thereby making it possible to determine the dimensions, positions and/or contours, at least of the first ink strips (10), in variable manner,
and
wherein an isotropic printing ink and/or printing compound (5a; 10a), in terms of color, is printed as the printing ink and/or printing compound in steps a) and b), in each instance.

2: The method according to claim 1, wherein
printing in step b) is carried out in such a manner that the first ink strips (10) cover or partially cover the first side flanks (1) of the ridges (5), without covering the second side flanks (2).

3: The method according to claim 1, wherein
printing in step b) is carried out in such a manner that the first ink strips (10) cover the ridges (5) on their first side flanks (1) more completely or in a greater or a different distance region from a center line (m) of the corresponding ridge (5) than on the second side flanks (2).

4: The method according to claim 1,
wherein the method comprises:
c) conformal deposition of a further pattern (23) having a plurality of second ink strips (20) parallel to the ridges (5) and to the first ink strips (10), but with a lateral offset (d′) to them, whereby surface regions of the ridges (5) and/or of the surface (50) between the ridges (5) not covered by the first ink strips (10) are covered, or covered in certain regions, by the second ink strips (20),
wherein the second ink strips (20) possess a different color, brightness and/or another visual, optical or wavelength-related quality from the first ink strips (10).

5: The method according to claim 4, wherein
in step b), the first side flanks (1) or at least strip-shaped surface regions of the first side flanks (1) are covered by the first ink strips (10), wherein in step c), the second side flanks (2) or at least strip-shaped surface regions of the second side flanks (2) are covered by the second ink strips (20).

6: The method according to claim 1,
wherein
the imprint (25) for producing the color-shift effect is configured as a strip pattern of at least three colors, in that center regions (3) of the ridges (5) located between the two side flanks (1, 2) are either left unprinted, selectively overprinted with third ink strips (12) of a third color, or are configured in some other manner to contrast with the first (1) and second side flanks (2) in terms of color or visually.

7: The method according to claim 1,
wherein
a relief structure (21) is configured from a plurality of first ridges (5), which are structured to be visually different on the two side flanks (1, 2), in terms of color or some other manner, and from a plurality of second ridges (15), which are structured to be visually different on the two side flanks (14, 16), in terms of color or some other manner, wherein the second ridges (15) intersect the first ridges (5) at a right angle or at another acute or obtuse angle, and
wherein the side flanks (14, 16) of the second ridges (15) are structured to be visually different from the side flanks (1, 2) of the first ridges (5), in terms of color or some other manner.

8: The method according to claim 1,
wherein
the imprint (25) formed from the ridges (5) and the ink strips (10, 20) is configured as a color-shift surface (30), having a color, brightness and/or other visual, optical, wavelength-related quality or one that can be determined using measurement technology, which appears homogeneous to the human eye over the surface dimension of the color-shift surface (30), but is dependent on the line of sight.

9: The method according to claim 1,
wherein
in step b), due to conformal printing of the pattern (22) composed of first ink strips (10) onto the surface (50) imprinted with the relief structure (21), such a pattern (22) consisting of first ink strips (10) is formed, the first ink strips (10) of which exclusively cover the first side flanks (1) of some or all the ridges (5) that face a first viewing direction (r1), or at least cover partial sections of any or all of the first side flanks (1), whereas the second side flanks (2), which face a second viewing direction (r2) that forms a mirror image of the first viewing direction (r1), remain uncovered by first ink strips over the entire surface of the color-shift surface (30).

10: The method according to claim 1,
wherein
in step c), by means of the conformal printing of the further pattern (23) composed of second ink strips (20) onto the surface (50) printed with the relief structure (21), such a pattern (22) composed of second ink strips (20) is formed, the second in strips (20) of which exclusively cover the second side flanks (2) of some or all the ridges (5) or cover at least partial sections of some or all the second side flanks (2), whereas the first side flanks (1) remain uncovered by second ink strips over the entire surface of the color-shift surface (30).

11: The method according to claim 1,
wherein
a color-shift surface (30) is produced by printing at least one pattern (22; 23) composed of first and/or second ink strips (10; 20), which surface possesses and/or produces a visual impression, from at least one viewing direction (r1; r2) inclined at a slant relative to the surface normal line (n) of the surface (50), which impression is influenced, determined and/or dominated only by one of two types of ink strips (10; 20) deposited in conformal manner.

12: The method according to claim 1,
wherein
a color-shift surface (30) is produced by printing the pattern (22) composed of first ink strips (10) and the further pattern (23) composed of second ink strips (20), the visual impression of which surface is influenced, determined and/or dominated, viewed from the first viewing direction (r1), by the pattern (22) composed of first ink strips (10), but not by the further pattern (23) composed of second ink strips (20), and the visual impression of which surface is influenced, determined and/or dominated, viewed from the second viewing direction (r2), by the further pattern (23) composed of second ink strips (20), but not by the pattern (22) composed of first ink strips (10).

13: The method according to claim 1,
wherein
a first color-shift motif is printed with the aid of the first ink strips, and a second color-shift motif, which is different from the first color-shift motif and/or from a motif inverted relative to it, is printed with the aid of the second ink strips,
wherein a first selection of ridges has corresponding length sections, in which not only is the first side flank overprinted with the corresponding first ink strip, but also the second side flank is overprinted with the corresponding second ink strips, and/or
wherein a second selection of ridges has corresponding length sections, in which neither is the first side flank overprinted with a first ink strip, nor is the second side flank overprinted with a second ink strip.

14: The method according to claim 1,
wherein
a plurality of specimens of imprints formed from ridges and ink strips is printed onto or for a plurality of specimens of printed materials, labels, banknotes or other documents or objects, wherein each specimen of the plurality of imprints is configured to be individually varied.

15: The method according to claim 14,
wherein
each specimen of the plurality of imprints is printed as a security feature onto a corresponding specimen or for a corresponding specimen of a printed material, a label, a banknote or another document or object, wherein each safety feature is printed in individually modified form, so as to allow identification, tracking, back-tracking, authentication or other marking of precisely this one corresponding specimen.

16: The method according to claim 14,
wherein
each specimen of the plurality of imprints comprises one or more color-shift surfaces, the outer contour, inner contour or motif/background contrast line of which is printed in the form of an individual, alphanumeric or other marking, in each instance.

17: The method according to claim 14,
wherein
each specimen of the plurality of imprints has an inner contour, within which the color-shift effect is left out or formed in some other way than outside of the inner contour, wherein the inner contour (8) is printed in the form of an individual, alphanumeric or other marking, in each instance.

18: The method according to claim 14,
wherein
each specimen of the plurality of imprints comprises a motif, wherein the type, the contour and/or the angle-dependent color appearance of the motif is configured in individually modified form for each specimen of the imprint.

19: An imprint (25) for individual marking of a surface (50) of a printed material (61), a label (62), a banknote (63) or another document (64) or object (60),
wherein the imprint (25) is structured as a color-shift surface (30) and has a relief structure (21) having a plurality of strip-shaped ridges (5),
wherein the ridges (5) are raised relative to the surface (50) and spaced apart from one another, and overprinted with ink strips (10, 20) in such a manner that they possess a different color, brightness or other visual, optical, wavelength-related quality or a quality that can be determined by means of measurement technology on opposite and/or differently oriented side flanks (1, 2), in each instance.

20: A set (100) of printed materials (61), labels (62), banknotes (63) or other similar documents (64) or objects (60), of which a plurality of specimens (65) is contained in the set (100),
wherein each specimen (65a, . . . , 65f) of the set (100) is printed or covered with an imprint (25a, . . . , 25f), in each instance, which is structured as a color-shift surface (30), wherein the color-shift surface (30) of the imprint (25a) is individually modified on each specimen (65a, . . . , 65f) and configured to be different from the imprints (25b, . . . , 25f) of all the other specimens (65b, . . . , 65f).
